(19) United States
(12) Patent Application Publication
(10) Pub. No.: US 2009/0150141 A1
(43) Pub. Date: Jun. 11, 2009

(54) Method and system for learning second or foreign languages

(76) Inventors: David Scott Wible, Taipei City (TW); Chin-Hwa Kuo, Taipei City (TW); Meng Chang Chen, Sijhih City (TW); Nai-Lung Tsao, Taipei City (TW)

Correspondence Address: RAYMOND R. MOSER JR., ESQ.;MOSER IP LAW GROUP, 1030 BROAD STREET, 2ND FLOOR, SHREWSBURY, NJ, 07702, US

(21) Appl. No.: 11/999,800

(22) Filed: Dec. 7, 2007

(51) Int. Cl. G06F 17/28; G06F 17/30

(52) U.S. Cl. 704/9; 707/3; 704/E19.001; 707/E17.014

(57) ABSTRACT

The present invention provides a method for providing linguistically interesting terms to a user, the method comprising processing a received digital text by a natural language processing technology, and then comparing the processed digital text with a linguistically interesting term database with a plurality of predetermined linguistically interesting terms. When the processed digital text has at least one predetermined linguistically interesting term, then at least one predetermined linguistically interesting term is extracted and is identified in a display.

### FIELD OF THE INVENTION

The present invention relates to machine aided language learning and writing systems and methods. In particular, the present invention relates to systems and methods for aiding users in learning foreign or second languages.

### BACKGROUND OF THE INVENTION

With the rapid development of global communications, the ability to write in a foreign or second language, especially the ability to write in English. However, those for whom English is a second or foreign language (for example, people who speak Chinese, Japanese, Korean or other non-English languages) often find it very difficult to write in English. The difficulty is frequently not in spelling, nor in grammar, but in idiomatic usage. Therefore, the biggest problem for these second or foreign language users while writing in English is determining how to polish sentences.

Spelling check and grammar check are helpful only when the user misspells a word or makes an obvious grammar mistake. These checking programs cannot be depended on for help in polishing sentences. A dictionary can be helpful as well, but mostly only for resolving reading and translation issues. Normally, looking up a word in a dictionary provides the writer with multiple explanations about the usages of the word, but without contextual information. As a result, it's too confusing and time-consuming for users to get any solution.

Generally, writers find it is very helpful to have good sample sentences that include idioms while writing for reference in polishing sentences. In light of these problems, a system and method, which aid second or foreign language users to notice and assimilate the idiomatic usage of sentences, is required.

### SUMMARY OF THE INVENTION

The main purpose of the present invention is to help a user to learn a second or foreign language when browsing a digital text.

Accordingly, the present invention provides a method for detecting for a user salient linguistic features or idiomatic expressions of the language that are potentially worthy of the user's attention (hereafter referred to as “linguistically interesting terms”), the method comprising to process a received digital text by a natural language processing technology, and then to compare the processed digital text with a database of linguistically interesting terms containing a plurality of predetermined linguistically interesting terms. When the processed digital text has at least one predetermined linguistically interesting term, the predetermined linguistically interesting term is extracted and is identified in a display.

### BRIEF DESCRIPTION OF THE DRAWINGS

The foregoing aspects and many of the attendant advantages of this invention are more readily appreciated and better understood by referencing the following detailed description, when taken in conjunction with the accompanying drawings, wherein:

FIG. 1 is a simplified block diagram of a linguistic retrieval system of the present invention.

FIG. 2 is a more detailed block diagram of the natural language processing engine according to a preferred embodiment of the present invention.

FIG. 3 shows an example of using the server's retrieval system of the present invention to aid a user to learn a language.

FIG. 4 shows a flow chart related to the FIG. 3.

### DETAILED DESCRIPTION OF THE PREFERRED EMBODIMENT

This application describes a computer system used for information retrieval that, through a sequence of computer and user interactions, allows the expression and the retrieval and display of relevant sentences using natural language processing (NLP) techniques.

The term “linguistically interesting terms” should be taken to include salient linguistic features or idiomatic expressions of the language that are potentially worthy of the user's attention such as compound words, idioms, lexical chunks, and other multi-word expressions.

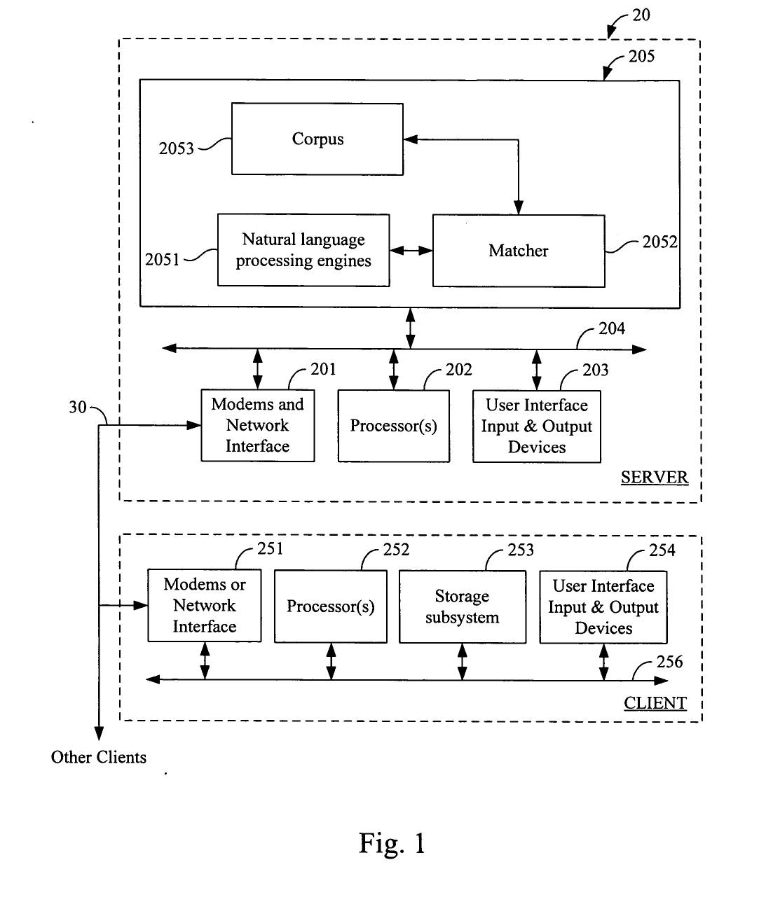

FIG. 1 is a simplified block diagram of a linguistic retrieval system of the present invention. The invention is typically implemented in a client-server configuration including a server 20 with the idiom retrieval system 205 and numerous clients, one of which is shown at 25. The server 20 receives queries from clients, does substantially all the processing necessary to respond to the queries, and provides these responses to the clients.

The server 20 includes one or more processors 202 that communicate with a number of peripheral devices via a bus 204. These peripheral devices typically include the retrieval system 205, a set of user interface inputs and output devices 203, and an interface to outside networks. This interface is shown schematically as a “Modems and Network Interface” block 201, and is coupled to corresponding interface devices in client computers via a wire or a wireless network connection 30.

Client 25 has the same general configuration, including one or more processors 252 that communicate with a number of peripheral devices via a bus 256. These peripheral devices typically include a storage subsystem 253, a set of user interface input and output devices 254, and modems and Network Interfaces 251. The input and output devices 254 are, for example, keyboard, mouse and display and so on.

The server's retrieval system 205 includes a natural language processing (NLP) engine 2051, a matcher 2052 and a corpus 2053. The corpus 2053 includes a plurality of linguistically interesting terms, such as idioms, lexical chunks or grammatical features, and has been established before a user enters queries into the retrieval system 205. After a sentence has been processed by the NLP engine 2051, the processed sentence is transferred to the matcher 2052 for further matching with the database stored in the corpus 2053. During matching, the matcher may extract interesting terms from the corpus 2053.

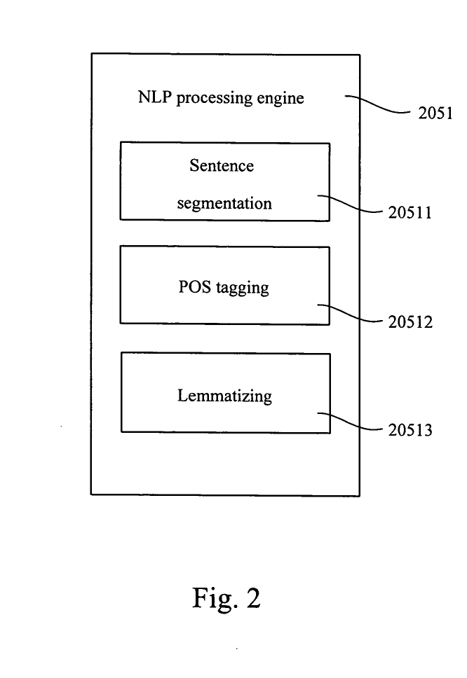

FIG. 2 is a more detailed block diagram of the natural language processing engine 2051 according to a preferred embodiment of the present invention. In this fig., the natural language processing engine 2051 includes sentence segmentation module 20511, POS tagging module 20512, lemmatizing module 20513. In other embodiments, different natural language processing engines also can be used in the present invention.

The first process to be performed in the natural language processing engine 2051 is to break text into sentences. A sentence segmentation module 20511 performs this process. Many Sentence segmentation methods can be used. The method currently widely used for segmenting a sentence is a regular grammar. In the simplest implementation of this method, the grammar rules attempt to end patterns of characters, such as period-space-capital letter, which usually occur at the end of a sentence.

POS tagging module 20512 performs the process of Part-of-Speech tag for a certain token in a sentence. A part-of-speech tag is a lexical category.

A lemma is the canonical form of a lexeme. Lemmatizing module 20513 performs the process of Lemmatisation is closely allied to the identification of parts-of-speech and involving the reduction of the words in a corpus to their respective lexemes.

Chunking module 20514 performs the process of extracting interesting terms from sentence.

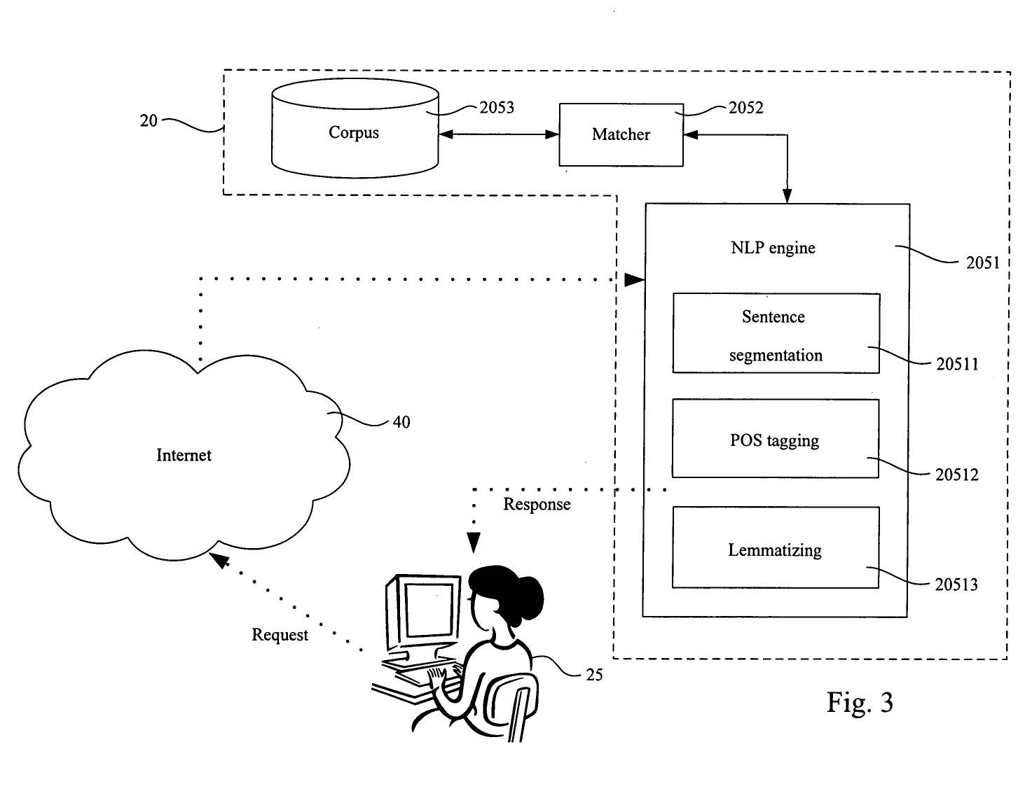

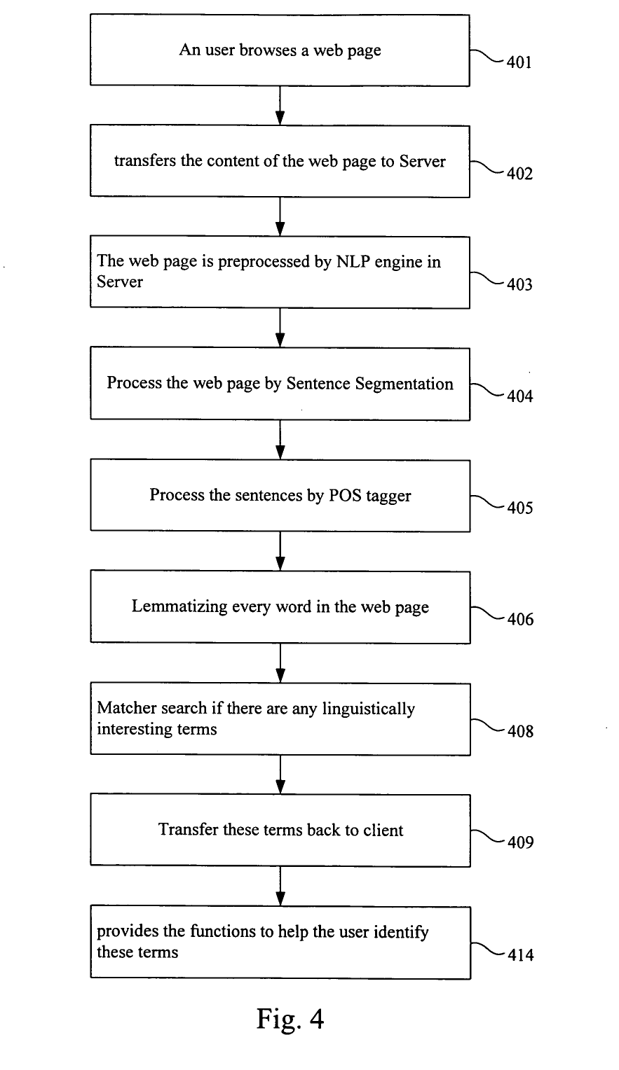

FIG. 3 shows an example of using the server's retrieval system of the present invention to aid a user to learn a language, such as English, Chinese, French and so on. FIG. 4 shows a flow chart related to the FIG. 3. FIG. 3 only shows the retrieval system 205 of the server 20. Please refer to FIG. 3 and FIG. 4 together. In the following embodiment, a web page is analyzed to describe the application of the present invention. It is noticed that present invention can be used to analyze any digital text.

According to an embodiment, a client 25 browses a web page through the Internet 40 in step 401. Typically, when a user browsing a web page finds an interesting term that he/she doesn't understand, he needs to input the terms into the search on-line or off-line dictionary to find its meaning. However, in this present invention, the client 25 may transfer all the content of the web page to the server 20 through the Internet 40 in step 402. The server 20 can help the client 25 to find all linguistically interesting terms in this web page. According to the present invention, the linguistically interesting terms are highlighted to inform the client 25. Therefore, when the client 25 browses the web page, he may learn the formulatic expressions, collocations, grammatical constructions and patterns of word usage.

The operation of the server 20 is described in the following. When server 20 receives this web page, the web page is preprocessed by the NLP engine 2051 in server 20. This process of preprocessing the web page is described in step 404 to step 406. According to the preferred embodiment, the web page is sent to the Sentence segmentation module 20511 to break the text into sentences in step 404. Next, these sentences are sent to the POS tagging module 20512 to arrange certain tokens in these sentences in step 405. Finally,every word in these sentences is reduced to their respective lexemes by Lemmatizing the module 20513 in step 406. In other embodiments, other NLP technologies can also be used in the present invention.

After the web page is preprocessed, the matcher 2052 may search the web page to find whether or not there are any linguistically interesting terms, such as idioms, therein in step 408. According to the present invention, the interesting terms search performed by the matcher 2052 is based on the database stored in the corpus 2053. In other words, the matcher 2053 compares the preprocessed web page with the corpus 2053 to extract linguistically interesting terms from the corpus 2053. These linguistically interesting terms are sent back to the client 25 in step 409. Finally, in step 410, the linguistic retrieval system provides the functions to help the client 25 identify these extracted linguistically interesting terms. For example, when the user browses the web page, the linguistically interesting terms are highlighted in the display and related explanation is also shown in the display to inform the client 25.

On the other hand, in a preferred embodiment, the extracted linguistically interesting terms along with additional examples, such as the relevant sentence, can be stored in the storage subsystem 253 as shown in the FIG. 1 for future reference. In another embodiment, the behavior of the client 25 browsing the web page and searching the linguistically interesting terms can be recorded in the storage subsystem 253. This record can be used to track the user's interesting field and related linguistic features.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. A computer-implemented method for providing linguistically interesting terms to a user, the method comprising:
receiving a digital text;
processing the digital text by a natural language processing technology;
comparing the processed digital text with a linguistically interesting term database to determine whether the processed digital text has at least one predetermined linguistically interesting term or not, wherein the linguistically interesting term database includes a plurality of predetermined linguistically interesting terms;
extracting the predetermined linguistically interesting term from the linguistically interesting term database when the processed digital text has at least one predetermined linguistically interesting term;
identifying the at least one linguistically interesting term in the digital text.

2. The method of claim 1, wherein the digital text is the content of a web page browsed by the user.

3. The method of claim 2, further comprising storing the behavior of the user browsing the web page and retrieving the linguistically interesting terms.

4. The method of claim 1, wherein identifying at least one linguistically interesting term to highlight the one linguistically interesting term in a display.

5. The method of claim 1, wherein processing the digital text by a natural language processing technology further comprising:
breaking the digital text into a plurality of sentences;
arranging a plurality of certain tokens in the sentences respectively; and
reducing every word in the sentences to their respective lexemes.

6. The method of claim 1, further comprising storing the extracted predetermined linguistically interesting term in a memory.

7. The method of claim 6, further comprising storing at least one sentence related to the extracted predetermined linguistically interesting term in a memory.

8. A tangible computer readable medium having computer executable instructions for performing a method of providing linguistically interesting terms to a user, the method comprising:
receiving a digital text,;
processing the digital text by a natural language processing technology;
comparing the processed digital text with a linguistically interesting term database to determine whether the processed digital text has at least one predetermined linguistically interesting term or not, wherein the linguistically interesting term database includes a plurality of predetermined linguistically interesting terms;
extracting the at least one predetermined linguistically interesting term from the linguistically interesting term database when the processed digital text has the at least one predetermined linguistically interesting term;
identifying the at least one linguistically interesting term in the digital text.

9. The medium of claim 8, wherein the digital text is the content of a web page browsed by the use

10. A system for providing linguistically interesting terms to a user, the system comprising:
a natural language processing device to process a received digital text to generate a processed digital text;
a linguistically interesting term database including a plurality of predetermined linguistically interesting terms;
a matcher for comparing the processed digital text with the linguistically interesting term database to determine whether the processed digital text has at least one predetermined linguistically interesting term or not, and to extract the predetermined linguistically interesting term from the linguistically interesting term database when the processed digital text has at least one predetermined linguistically interesting term; and
a display to display the digital text, wherein the at least one linguistically interesting term is identified.

11. The system of claim 10, wherein the digital text is the content of a web page browsed by the user.

12. The system of claim 11, further comprising a memory to store the behavior of the user browsing the web page and retrieving the linguistically interesting terms.

13. The system of claim 10, wherein at least one linguistically interesting term is identified by highlighting the at least one linguistically interesting term in the display.

14. The system of claim 10, wherein a natural language processing device further comprises:
a sentence segmentation module for breaking the digital text into a plurality of sentences;;
a POS tagging module for arranging a plurality of certain tokens in the sentences respectively; and
a lemmatizing module for reducing every word in the sentences to their respective lexemes.

15. The system of claim 10, further comprising a memory to store the extracted at least one predetermined linguistically interesting term in a memory.

16. The system of claim 15, wherein the memory further stores at least one sentence related to the extracted at least one predetermined linguistically interesting term.
